(19) United States
(12) Patent Application Publication
(10) Pub. No.: US 2013/0101859 A1
(43) Pub. Date: Apr. 25, 2013

(54) Surface Coatings Having Anti-Ice Properties

(71) Applicants: Martina Hirayama, Nussbaumen (CH); Konstantin Siegmann, Zurich (CH); Giuseppe Meola, Winterthur (CH); Carsten Schaefer, Muehldorf (DE); Karin Daenhardt, Winterthur (CH)

(72) Inventors: Martina Hirayama, Nussbaumen (CH); Konstantin Siegmann, Zurich (CH); Giuseppe Meola, Winterthur (CH); Carsten Schaefer, Muehldorf (DE); Karin Daenhardt, Winterthur (CH)

(73) Assignee: CLARIANT FINANCE (BVI) LIMITED, Tortola (VG)

(21) Appl. No.: 13/521,357

(22) PCT Filed: Jan. 10, 2011
(86) PCT No.: PCT/CH2011/000003

§ 371 Date: Jul. 10, 2012

(30) Foreign Application Priority Data
Jan. 11, 2010 (EP) 10000156.9

(51) Int. Cl. C09D 5/00

(52) U.S. Cl. CPC C09D 5/00
USPC 428/441; 428/451; 428/461; 428/507; 428/523; 524/548; 524/553; 524/555; 524/558

(57) ABSTRACT

The present invention relates to coatings comprising a matrix and an active polymer embedded therein, characterised in that either (i) the matrix is cross-linked, or (ii) the active polymer is cross-linked or (iii) the active polymer is covalently bonded to the matrix; and in case of a cross-linked active polymer a matrix may be omitted; and the active polymer contains structural units according to the description, and a cross-linking agent and/or coupling reagent are optionally contained therein. Said coatings exhibit outstanding anti-ice properties. The invention further relates to shaped articles and devices comprising such coatings, and to a method for the manufacturing and the use of such coatings, shaped articles and devices.

The present invention relates to surface coatings having anti-icing properties, shaped articles and devices comprising such coatings, methods for manufacturing and for using such coatings, shaped articles and devices.

Freezing of surfaces and avoiding or delaying such freezing, respectively, is a well known and much-studied field. Unwanted freezing occurs at a variety of surfaces, surfaces of power generating equipment (such as rotor blades for wind turbines), of means of transportation (including surfaces of wings and rotors, transparent screens) and of packagings are named as an example.

GB1494090 describes curable compositions which contain a specific aqueous dispersion and a thermosetting resin, as well as substrates coated therewith. In this document, however, no coatings are disclosed wherein an active polymer is embedded in a matrix via covalent bonding. Further, this document does not disclose anti-icing properties of the coatings disclosed therein.

EP0979833 discloses aqueous dispersions containing specific acrylate derivatives and their use as thickeners. The compounds disclosed therein differ from the inventive compounds of formula (Ia) of the present invention, since R¹ does not represent hydrogen. Further, neither surface coatings nor anti-ice properties are discussed in this document.

DE20023628 (and U.S. Pat. No. 700,392 as well) discloses transparent glazings, which are combined with an adsorbed frost-protecting layer. In said protecting layer, incorporating of an active polymer in a matrix via covalent bonding is not provided for.

Applied Thermal Engineering, 20 (2000) 737 describes coatings which delay icing. As coatings, hydrophilic polymers such as VP and MMA are used, which are optionally combined with a non-crosslinked matrix of PIB. However, there are no coatings disclosed in which an active polymer is embedded in a matrix via covalent bonding. The thus produced coatings show a little effect, poor mechanical properties (stickiness) and are applied in thick coatings.

EP1198432 describes anti-freeze coatings containing a mixture of a hydrophilic polymer which is combined with either a mesoporous material or with an organic/inorganic adsorption material. The components described in this document are present as a physical mixture. The resistance of these coatings proves to be insufficient in various applications.

The object of the present invention is therefore to provide alternative anti-ice coatings which solve one or more of the abvoresaid problems.

This object is achieved by providing a coating as described below, in particular according to the features of claims 1, 2, 7, 11. Further aspects of the invention are specified in the independent claims as well as in the description. Advantageous embodiments are specified in the dependent claims as well as in the description. In the context of the present invention, the various embodiments and preferred ranges may be combined at will. Further, specific embodiments, ranges or definitions may not apply or may be omitted, respectively.

In the context of the present invention, important terms are particularly explained below; provided the specific context does not indicate otherwise, these explanations shall apply.

The term “sol-gel” is generally known, and particularly comprises sol-gels which are formed by hydrolysis and condensation of metal- or semimetal-precursors, respectively (“sol-gel-process”). The sol-gel-process is a suitable method for manufacturing non-metallic inorganic or hybrid-polymeric coatings from colloidal dispersions, the so-called sols. In a first basic reaction, fine particles are formed therefrom in solution. A network, consisting of metal- and semimetal precursors, is termed a gel.

Suitable are precursors of formula (IV)

R¹¹ₙMR¹²ₐ₋ₙ (IV)

wherein
R¹¹ independently represent a non-hydrolyzable group, such as C₁-C₈ alkyl, particularly methyl and ethyl;
R¹² independently represent a hydrolyzable group, such as C₁-C₈ alkoxy, particularly methoxy and ethoxy;
M represents an element from the group comprising Si, Al, Zr and Fe;
a is 4 (where M is Si, Zr) or a is 3 (where M is Al, Fe);
n is 0, 1, 2, 3.

Sol-gels may consist of one type of precursor or of a mixture of various precursors. If a silicon alkoxide is used, the preferred silanes of the above general formula are tetramethoxysilane and tetraethoxysilane (n=0). Particularly suitable are mixtures of tetraalkoxysilane and trialkoxyorganosilane (n=1).

Preferred precursors thus contain a mixture of

SiR¹²₄(IVa) and R¹¹SiR¹²₃ IVb)

wherein R¹¹ and R¹² have the above mentioned meaning.

In the inventive manufacturing method a composition for coating is applied to the corresponding surface which contains the above mentioned sols.

The term “polymer” is generally known, and in particular includes engineering polymers from the group of polyolefins, polyesters, polyamides, polyurethanes, polyacrylates. Polymers may be present as a homopolymers, co-polymers or blends.

The term “substrate” is generally known; in particular, it encompasses all shaped articles with a solid surface which are susceptible to coating. The term substrate is therefore independent from a specific function or dimension. Substrates may be “uncoated” or “coated”. The term “uncoated” refers to those substrates that lack the inventive outer layer; however, do not exclude the presence of other layers (e.g. a layer of varnish, a label, and the like).

The concept of “functional groups” is generally known and refers to groups of atoms in a molecule which significantly affect the material properties and the reaction behaviour of the molecules carrying them. Provided that a compound (a polymer, a monomer, a precursor, etc.) is referred to as “functionalized” or “unfunctionalized”, this refers to the presence, or absence respectively, of functional groups. If there is a functionalization, this particularly means an effective amount of these functional groups is present to achieve the desired effect. In the context of the present invention, this term particularly refers to groups covalently bond to a sol-gel or to a polymer.

The term “anti-icing”, also in expressions such as “anti-icing coating”, is well known. Anti-icing means that the icing of surfaces is prevented or delayed. Without being bound by theory, the anti icing effect may be explained in the present case by the ability of hydrophilic polymers to incorporate large amounts of water. The hydrophilic property of the polymer causes the polymer surface is moistened in layers by the condensed water. The freezing of the absorbed water is suppressed and an icing of the surface is prevented or delayed.

The present invention therefore relates in a first aspect to coatings containing (i.e. comprising or consisting of) a matrix and incorporated therein an active polymer, characterized

in that either (i) the matrix is crosslinked or (ii) the active polymer is crosslinked or (iii) the active polymer is covalently bound to the matrix; and
in that in case of a crosslinked active polymer (ii) the matrix may be absent; and
in that the active polymer contains structural units of the formula

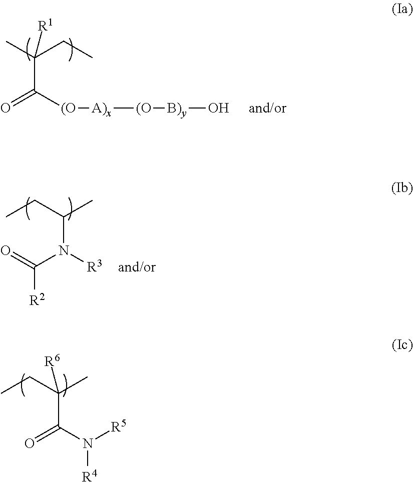

wherein
R¹ represents hydrogen or C₁-C₆-alkyl,
A represents a C₂-C₄-alkylen group,
B represents a C₂-C₄-alkylen group, with the proviso that A is different from B,
x, y independently represent an integer from 1-100,
R² and R³ independently represent hydrogen or C₁-C₆-alkyl, or
R² and R³-together with the nitrogen atom and the carbonyl group-form a ring of 5, 6 or 7 ring atoms (i.e. a lactame form),
R⁴ and R⁵ independently represent hydrogen or C₁-C₆-alkyl or C₁-C₆-cycloalkyl, or
R⁴ and R⁵— together with the nitrogen atom-form a ring of 5, 6 or 7 ring atoms,
R⁶ represents hydrogen or C₁-C₆-alkyl; and
   in that crosslinkers and/or coupling reagent are optionally present.

Compared to known coatings, the coatings of the present invention show improved properties, in particular, improved anti-icing and/or improved durability and/or thinner layers. This aspect of the invention shall be explained below.

Particularly suitable embodiments of the present invention are explained below.

Layer Thickness:

the thickness of the inventive coating is not critical and can be varied over a broad range. Coatings based on a matrix of polymers typically have thicknesses of 0.5-1000 μm, preferably 10-80 μm; coatings based on a matrix of sol-gels typically have a thickness of 0.1-100 μm, preferably 0.5-10 μm; coatings free of a matrix typically of a thickness of 0.1-100 μm, preferably 0.5-10 μm. Compared to known coatings, the inventive coatings may be applied in a significantly reduced layer thickness without adversely affecting the anti-icing effect.

Active Polymer:

According to the invention, the choice of active polymer is of key importance. The inventive coatings contain active polymers; they are present at the surface or within the matrix (“embedded”), preferably in an effective amount. The amount of polymer may vary over a broad range. In an advantageous embodiment, the ratio of active polymer to matrix is in the range of 20:70 to 98:2, particularly preferably 55:45 to 90:10. It has been found that in this range both may be achieved, good anti-icing properties and good durability of the coating. Suitable structural units of such polymers are described below; they advantageously contain (or consist of) acrylates of formula (Ia) and/or vinyl amides of formula (Ib) and/or acrylamides of formula (Ic) and optionally crosslinking agents (e.g. of formula (IIa) and/or (IIb)) and optionally coupling reagents (e.g. of the formula (III)). One or more different components named may be present.

Acrylate (Ia):

In a preferred embodiment, the active polymer contains between 1 and 100 mol-% structural units of formula (Ia)

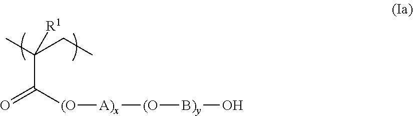

wherein
R¹ represents hydrogen or C₁-C₆-alkyl,
A represents C₂-C₄-Alkylenge groups and,
B represents C₂-C₄-alkylene groups, with the proviso that A is different from B, and
x, y independently represent an integer from 1-100.

R¹ represents in a preferred embodiment hydrogen or methyl.

A and B represent C₂-C₄-Alkylen groups, with the proviso that A is not equal to B. This means that the structural units of formula (Ia) may be alkoxylated with up to 200 C2-C4-alkoxy moieties; wherein this may be either a block-wise alkoxylation with at least two of ethylene oxide, propylene oxide or butylene oxide or a (random) mixed alkoxylation with at least two of ethylene oxide, propylene oxide or butylene oxide.

In a preferred embodiment, A and B represent an ethylene or propylene group. Particularly preferably, A is a propylene group and B is an ethylene group. Specifically, A represents a propylene group and B represents an ethylene group, with the proviso that x=1 to 5 and y=3 to 40.

In case of a random-mixed alkoxylation with EO and PO, the ratio of ethylene- to propylene groups is preferably 5:95 to 95:5, particularly preferably from 20:80 to 80:20 and specifically 40:60 to 60:40.

For example, the active polymer contains 2 to 99, preferably 5 to 95, particularly 20 to 80 and specifically 40 to 60 mol-% structural units of formula (Ia).

Depending on the structure of the structural unit of formula (Ia), the properties of the active polymers may be modified such that they specifically influence, according to the conditions given, the anti-icing properties. Particularly good results were found when in a compound of formula (Ia) A represents propane-1,2-diyl, B represents ethane-1,2-diyl, X represents 1 to 3 (preferably 2), y represents 3 to 7 (preferably 5) and R¹ represents methyl.

The manufacturing of polymers based on structural units of formula (Ia) is known per se and may by effected by polymerizing alkoxylated acrylic or methacrylic acid derivatives (hereinafter, the term acrylic acid also denotes methacrylic acid). They are obtainable by alkoxylation of acrylic acid or 2-alkylacrylic or acrylic acid monoesters of ethylene glycol, propylene glycol or butylene glycol (2-hydroxyethyl acrylate, 2-hydroxypropyl acrylate or 2-hydroxybutyl acrylate) or 2-Alkylacryl acid monoesters of ethylene glycol, propylene glycol or butylene glycol (2-hydroxyethyl-2-alkyl acrylate, 2-hydroxypropyl-2-alkyl acrylate or 2-hydroxybutyl-2-alkyl acrylate). Particularly preferably the alkoxylated acrylic acid derivatives are manufactured by DMC-catalyzed alkoxylation of 2-hydroxypropyl acrylate or 2-hydroxypropyl-2-alkyl acrylate, especially by DMC-catalyzed alkoxylation of 2-hydroxypropyl-2-methacrylate. DMC catalysis allows, in contrast to the traditional alkali-catalyzed alkoxylation, a very specific synthesis of monomers having precisely defined properties while avoiding unwanted side products. DE-A-102006049804 and U.S. Pat. No. 6,034,208 teach the advantages of DMC catalysis.

Vinylamide (Ib):

In a further embodiment, the active polymer contains between 1 and 100 mol % structural units formula (Ib)

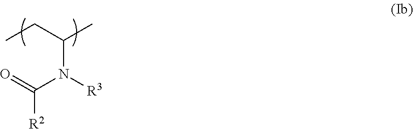

wherein
R² and R³ independently represent hydrogen or C₁-C₆-alkyl, or
R² and R³— together with the nitrogen atom and the carbonyl group-form a ring of 5, 6 or 7 ring atoms (i.e. a lactame form).

R² and R³ together preferably contain at least one, preferably at least two carbon atoms.

Examples are, inter alia, N-vinyl formamide (NVF), N-vinyl methylformamide, N-vinyl methylacetamide (VIMA), N-vinyl acetamide, N-vinyl pyrrolidone (NVP), 5-methyl-N-vinyl pyrrolidone, N-vinyl valerolactam, N-vinyl imidazole and N-vinyl caprolactam. In a preferred embodiment of the invention, the structural units of formula (I) are derived from N-vinyl acetamide, N-methyl-N-vinyl acetamide, vinylpyrrolidone and vinyl-caprolactam.

Polymers based on structural units of formula (Ib) are obtainable by the polymerization of the corresponding vinyl monomers, which can be prepared in known manner.

The preferred amounts of structural units of formula (Ib) are between 2 to 99, preferably 5 to 95, preferably 20 to 80 and especially 40 to 60 mol %.

In one embodiment, the structural units of formula (Ib) and the structural units of formula (Ia) complement to 100 mol %. Such copolymers are known per se or can be prepared by known methods.

Depending on the structure of the structural unit of formula (Ib), the properties of the active polymers may be modified such that they specifically influence, according to the conditions given, the anti-icing properties. Particularly good results were found when NVP was used as compound (Ib).

Acrylamide (Ic):

In a further embodiment, the active polymer contains between 1 and 100 mol % structural units formula (Ic)

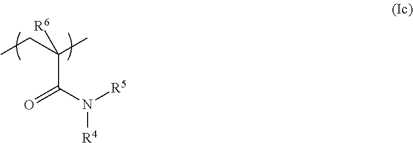

wherein
R⁴ and R⁵ independently represent hydrogen or C₁-C₆-alkyl or C₁-C₆-cycloalkyl, or represent-together with the nitrogen atom-a ring of 5, 6 or 7 ring atoms,
R⁶ represents hydrogen or C₁-C₆-alkyl.

R⁴ and R⁵ together preferably contain at least one, particularly at least two carbon atoms.

The structural units of formula (Ic) are preferably derived from (meth) acrylamide, N-alkyl (meth) acrylamides, N,N-dialkyl (meth) acrylamides, 2-dimethylamino methacrylate, N-acryloylpyrrolidine, N-acryloyl morpholine and N-acryloylpiperidine.

The preferred amounts of structural units of formula (Ic) are between 2 to 99, preferably 5 to 95, preferably 20 to 80 and especially 40 to 60 mol %.

In one embodiment, the structural units of formula (Ia) and the structural units of formula (Ia) complement to 100 mol %.

Depending on the structure of the structural unit of formula (Ic), the properties of the active polymers may be modified such that they specifically influence, according to the conditions given, the anti-icing properties.

Polymers based on structural units of formula (Ic) are obtainable by the polymerization of the corresponding acrylic monomers, which can be prepared in known manner.

In further embodiments, the active polymer contains structural units (i) of formula (Ia) or (ii) of the formulas (Ia) and (Ib), or (iii) of the formulas (Ia) and (Ic), or (iv) of formulas (Ia) and (Ib) and (Ic).

In a preferred embodiment, the active polymer contains structural units of formulas (Ia) and (Ib).

In a further embodiment, the structural units of formulas (Ia), (Ib) and (Ic) complement to 100 mol %.

In a further embodiment, the structural units of formulas (Ia), (Ib), (Ic) and coupling reagent (III) complement to 100 mol %.

Further Structural Units:

Besides the structural units of formula (Ia) (Ib) and (Ic), the active polymers may contain further structural units which are different from them. In this further embodiment, the structural units of formulas (Ia), (Ib) and (Ic) and the below-mentioned “further” structural units complement to 100 mol %. These further structural units are those which are derived from olefinically unsaturated monomers which contain O, N, S or P. Preferably, the polymers contain oxygen-, sulphur- or nitrogen-containing co-monomers, in particular oxygen or nitrogen-containing co-monomers. Suitable further structural units are for example those that are derived from styrene sulfonic acid, acrylamido methylpropane sulfonic (AMPS®), vinyl sulfonic acid, vinyl phosphonic acid, allyl sulfonic acid, methallyl sulfonic acid, acrylic acid, methacrylic acid and maleic acid (and its anhydride) as well as the salts of the previous mentioned acids with monovalent and divalent counterions.

Counter-ions preferably used are lithium, sodium, potassium, magnesium, calcium, ammonium, monoalkylammonium, dialkylammonium, trialkylammonium or tetraalkylammonium, wherein the alkyl substituents of the amines are independently C₁ to C₂₂ alkyl residues which may be substituted by 0 to 3 hydroxyalkyl groups whose alkyl chain length may vary in a range of C₂ to C₁₀. In addition, one-fold to threefold ethoxylated ammonium compounds, having different degrees of ethoxylation, may be applied. Particularly preferred counterions are sodium and ammonium.

The degree of neutralization of the mole fraction of the previous described acids may also deviate from 100%. Suitable are all degrees of neutralization between 0 and 100%, particularly preferred is the range between 70 and 100%.

Furthermore, esters of acrylic acid, or metacrylic acid respectively, with aliphatic, aromatic or cycloaliphatic alcohols having a carbon number of C₁ to C₂₂ may be considered suitable monomers. Further, 2- and 4-vinyl pyridine, vinyl acetate, glycidyl methacrylate, acrylonitrile, vinyl chloride, vinylidene chloride, tetrafluoroethylene and DADMAC are suitable monomers.

The proportion of such other structural units is for example 1 to 99, preferably 1.2 to 80, particularly 1.5 to 60 and especially from 1.7 to 40 mol %. In one embodiment, the structural units of formula (II) and these further structural units complement to 100 mol %.

### Matrix:

According to the invention, the choice of the matrix is not critical, so that a multitude of materials known to the skilled person may be employed. Suitable materials include polymer layers (such as polyurethanes, polyacrylates, epoxy resins) and coatings of the sol-gel type. The choice of a suitable layer depends inter alia on the substrate and on the choice of the active polymer, and may be determined by the skilled person in simple experiments. Sol-gel type layers show very good effects, are very flexible to apply and to manufacture, which preferences them.

### Crosslinking:

Either the active polymer or the matrix or the active polymer and the matrix of the inventive coatings are crosslinked. The type of crosslinking depends on the materials used. Particularly good results are found when active polymer and/or matrix are partially crosslinked. The extent of crosslinking-not crosslinked, partially crosslinked, fully crosslined—may be determined by various methods known per se.

Cosslinking of the active polymer is advantageously determined by means of swelling. Suitable degrees of crosslinking are in a range which still allows absorption of water into the network.

Crosslinking of sol-gel layers is advantageously determined advantageously by means of IR spectroscopy. Suitable relative degrees of crosslinking are in the range up to 80%, preferably 15-80%.

In an advantageous embodiment, the invention relates to coatings as described herein, comprising an active polymer and a matrix, wherein
a. the matrix is selected from the group consisting of sol-gels and polymer layers;
b. the active polymer contains 1-100 wt-% structural units of formula (Ia), (Ib) and/or (Ic);
c. the active polymer is covalently embedded in said matrix.

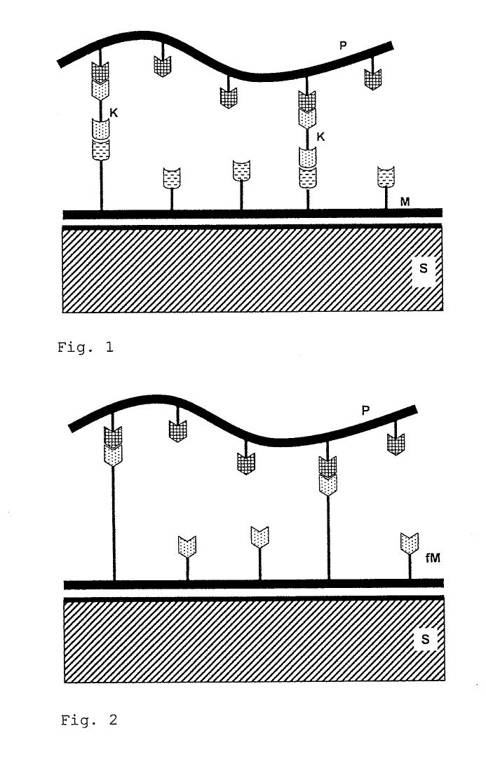

The active polymer may be embedded in said matrix in a manner known per se, for example (cl) by reacting the polymer with a coupling reagent (see FIG. 1) or, (c2) by direct reaction of the active polymer with a functionalized matrix (see FIG. 2). Without being bound by theory, it is believed that the covalent bonding of the active polymer to the matrix results in a surprising improvement in the property profile of the inventive coating. This embodiment will be explained in detail below and is shown schematically in FIGS. 1 and 2. In the figures, (P) denotes the active polymer having the structural units of formula (I), (K) denotes the coupling reagent, (M) denotes the matrix, (fM) denotes the functionalized matrix and (S) denotes the substrate.

Covalent attachment via coupling reagent (III) (variant cl): In the context of the present invention, the term “coupling reagent” denotes such compounds causing a covalent bond of the active polymer to the matrix.

In one embodiment, the active polymer contains one or more coupling reagents, in particular from the group comprising silanes functionalized by isocyanate (IIIa) and silanes functionalized by azidosulfonyl (IIIb).

In principle, all such silanes are suitable, preferred are silanes of formula (IIIa) and/or (IIIb)

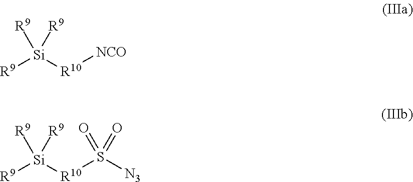

wherein
R¹⁰ represents a bi-functional hydrocarbon residue having 1-20 carbon atoms, preferably represents a C₆₋₁₀ aryl residue, a C₁₋₁₀ alkandiyl residue, a C₃₋₁₀ cycloalkyl residue;
R⁹ independently represents a hydrolizable group, such as e.g. C₁₋₈ alkoxy, particularly methoxy and ethoxy.

Covalently bond active polymers thus contain in addition to the structural units of formulas (I) further structural units which are derived from the reaction with the coupling reagent, such as, for example, compounds of formula (IIIa) or (IIIb) respectively. These structural units effect a covalent bonding of active polymer and the matrix. In the case of compounds of formula (IIIb), it is assumed that during curing of the coating (for example, temperatures in the range of 160° C.) molecular nitrogen is cleaved-off from the molecule, thereby forming a nitrene. The resulting nitrene may then be inserted into a CH bond of the active polymer (insertion reaction), causing a covalent bond. The proportion of such other structural units is for example 1 to 99, preferably 1.2 to 80, especially 1.5 to 60 and specifically from 1.7 to 40 mol %. In one embodiment, the structural units of formulas (I) and these further structural units of formula (IIIa) and/or (IIIb) complement to 100 mol %.

Coupling reagents, in particular compounds of formula (IIIa) and (IIIb), are generally known and may be prepared by known methods.

Coupling reagents, in particular compounds of formula (IIIa) and (IIIb), are particularly suitable for linking to a matrix selected from the group of sol-gels. Provided the inventive coating contains a coupling reagent, a) the ratio of active polymer to matrix advantageously is in the range from 30:70 to 98:2 (w/w) and/or b) said polymer preferably contains 10-50 wt-% coupling agent of formula (IIIa) and/or (IIIb).

Covalent attachment via functionalized matrix (variant c2): The direct covalent attachment of polymers to a functionalized matrix, in particular to a functionalized sol-gel or to a functionalized polymer layer, is known per se or can be carried out in analogy to known processes. In the context of the present invention, the term “functionalized matrix” particularly denotes those compounds which cause a covalent bond of the active polymer to the matrix. In one embodiment, the matrix contains an effective amount of functional groups selected from the group comprising isocyanates. The amount of such functional groups may vary over a broad range and may be optimized in a series of routine experiments in view of the components given and the activity profile desired. In this embodiment, sol-gels are particularly suitable as a matrix.

In a further advantageous embodiment, the invention relates to coatings as described herein, comprising an active polymer and a matrix, wherein
a. the matrix is selected from the group consisting of sol-gels and polymer layers;
b. the active polymer contains 1-100 wt-% structural units of formula (Ia), (Ib) and/or (Ic).

In the context of the present invention, the term “crosslinker” denotes those compounds which cause a two-dimensional and/or three-dimensional crosslinking of the active polymer. Without being bound by theory, it is believed that the active polymer network results in a surprising improvement in the property profile of the inventive coating. This embodiment shall be explained in further detail below.

### Crosslinking Agent (II):

In one embodiment, the active polymer contains one or more crosslinking agents, particularly from the group comprising diisocyanates and diglycidyl ethers. In principle, all diisocyanates and all glycidyl ethers are suitable as crosslinking agents; preferred are the diisocyanates of the formula (IIa) and glycidyl ethers of the formula (IIb). Such compounds of formula (II) are generally known and can be prepared by known methods.

Diisocyanates of the formula (IIa)

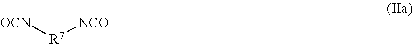

are preferred, wherein R⁷ represents a bi-functional hydrocarbon residue having 1-20 carbon atoms. R⁷ preferably represents a C₆₋₁₀ aryl residue, a C₁₋₁₀ alkandiyl residue, a C₃₋₁₀ cycloalkyl residue. MDI, TDI (2-tolyl diisocyanate) HDI and IPDI, particularly TDI are mentioned as examples of suitable diisocyanates.

Diglycidyl ethers of the formula (IIb)

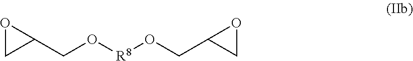

are preferred, wherein R⁸ represents a bi-functional, optionally substituted, hydrocarbon residue having 1-20 carbon atoms and 0-4 oxygen atoms. R⁸ preferably represents a C₆₋₁₀ aryl residue, a C₁₋₁₀ alkandiyl residue, a C₃₋₃₀ cycloalkyl residue or (C₆₋₁₀ aryl)-(C₁₋₁₀ alkandiyl)-(C₆₋₁₀ aryl)-residue. R⁸ particularly preferably represents phenyl or bishpehnyl-A.

Crosslinked active polymers therefore contain, besides the structural units of formulas (I) (i.e. (Ia) (Ib) and (Ic)), further structural units which are derived by the reaction with the crosslinking agent, i.e for example with compounds of the formulas (IIa) and/or (IIb). These structural units cause crosslinking of the active polymer. The proportion of such other structural units is, for example, 1 to 99, preferably 1.2 to 80, especially 1.5 to 60 and specifically from 1.7 to 40 mol %. In one embodiment, the structural units of formulas (I) and these further structural units, derived from compounds of formula (II), complement to 100 mol %.

Provided that the inventive coating is crosslinked, the invention provides, in one advantageous embodiment, coatings which do not contain matrix.

Provided the inventive coating is crosslinked, the active polymer preferably contains 10-90 wt.-% structural units of formula (I), in particular structural units of formula (I) containing a lactam, preferably a caprolactam.

In a further advantageous embodiment, the invention relates to coatings as described herein, comprising an active polymer and a matrix, wherein
a. the matrix is selected from the group consisting of sol-gels and polymer layers
b. the matrix shows a relative degree of crosslinking of less than 80%, preferably 15-80%, as determined by IR spectroscopy;
b. the active polymer contains 1-100 wt-% structural units of formula (Ia), (Ib) and/or (Ic);

In this embodiment, the invention relates to such coatings in which the matrix is crosslinked and the active polymer is insignificantly or not, preferably not, crosslinked. Without being bound by theory, it is believed that crosslinking of the matrix results in a surprising improvement in the property profile of the inventive coating. This embodiment will be explained in detail below.

In an advantageous embodiment, the invention relates to such coatings in which the ratio of active polymer to matrix is in the range of 30:70 to 98:2, preferably 55:45 to 70:30 (w/w).

In an advantageous embodiment, the invention relates to such coatings in which said matrix is selected from the group comprising sol-gels.

In an advantageous embodiment, the invention relates to such coatings in which said matrix is a polymer selected from the group comprising polyolefins, polyesters, polyamides, polyurethanes, polyacrylates.

In an advantageous embodiment, the invention relates to such coatings in which said polymer contains 40-60 wt-% structural units of formula (Ib), in which a lactam, preferably a caprolactam, is contained.

In an advantageous embodiment, the invention relates to such coatings in which said polymer additionally contains 10-50 wt-% crosslinking agent of the formula (IIb), in which R⁸ represents biphenyl-A.

In a second aspect, the invention relates to shaped articles, and devices respectively, comprising a substrate and coating as described above as the outermost coating. Below, this aspect of the invention shall be described.

### Substrate:

According to the invention, the choice of substrates is not critical; a multitude of substrates known to the skilled person may be employed. Suitable substrates posses a surface which can be coated; such surfaces may be selected from the group consisting of metallic materials, ceramics, glass-like materials, polymeric materials and cellulosic materials.

Preferred metallic materials, relevant in the context of the present invention, are alloys of aluminium, iron and titanium.

Preferred polymeric materials, relevant in the context of the present invention, are polymerizates, polycondensates, polyadducts, resins and composites (eg GRP). Preferred cellulose-containing lignin-containing materials are paper, cardboard, wood.

The substrates themselves may be constructed of several layers (“sandwich structure”), already include coatings (e.g. a painting, a print), being mechanically treated (e.g. polished) and/or chemically treated (e.g. etched, activated).

### Shaped Article:

As previously mentioned, there is a need for a broad range of devices to provide them with anti-icing properties. Therefore, the present invention relates to such devices in the broadest sense. In particular, devices are included which are used i) in power generation plants and power distribution plants, ii) in means of transportation, iii) in the food sector, iv) in measuring and controlling devices v) in heat transfer systems vi) in crude oil transportation and natural gas transportation.

By way of example, reference may be made to the following devices/equipment:
power generation plants and power distribution plants: high voltage power lines, rotor blades for wind turbines
means and facilities of transportation: wings, but also blades, fuselage, antennas, windows of aircraft; Viewing windows of motor vehicles; hull, but also mast, fin rudder, takelage of ships; external surfaces of railway wagons; surfaces of traffic signs.
Food sector: lining of refrigerators, Packaging of foodstuffs.
Measuring and controlling devices: sensors.
Heat transfer systems: devices for the transport of ice slurry; surfaces of solar systems; surfaces of heat exchangers.
crude oil transportation and natural gas transportation: surfaces which come into contact with gases upon transportation of crude oil and natural gas, for preventing gas hydrate formation.

According to the invention, the coatings described herein may cover the device in whole or in part. The degree of coverage depends on, among other things, the technical necessity. For rotor blades, it may be sufficient coating the front edges to achieve a sufficient effect; for viewing windows, however, a complete or nearly complete coating is advantageous. To ensure the anti-icing properties, it is important that the coating described herein is present as the outermost (upper-most) layer.

Linking the coatings described herein to a substrate may be achieved by covalent bonding, ionic bonding, van der Waals interaction or dipolar interaction. Sol-gels are preferably linked by covalent interaction to the substrate; polymers adhere to substrates mainly due to dipolar or van der Waals-interaction.

The invention further relates to the use of the coatings described herein as an anti-ice coating. The invention also relates to a method of using an outer-most layer as described herein as an anti-ice coating.

The invention relates, in a third aspect, to methods for manufacturing a coating (or a coated substrate respectively) as described herein. The manufacturing of coated substrates is known per se, but was not yet applied to the specific components described herein. In principle, the methods for manufacturing depend on the composition of the matrix and the active polymer of the inventive coatings.

Accordingly, the invention relates to a method for manufacturing of a coated substrate as described herein characterized in that a) an uncoated substrate is provided and optionally activated; b) a composition comprising a matrix and an active polymer as described herein is provided; and c) said substrate is coated with said composition, for example, by dip coating or spray coating.

Advantageous embodiments of the described manufacturing method will be explained in detail hereinafter. Further, in the context of the various manufacturing methods, reference to the examples is made.

### Sol-Gel Layers:

Provided the matrix of the sol-gel type, the manufacturing method of the inventive coatings comprises either i) providing a sol-gel and applying said sol-gel on the uncoated substrate, or ii) providing and applying Sol-gel precursors on the uncoated substrate with subsequent hydrolysis and condensation to form a sol-gel. The manufacturing of a sol-gel from the corresponding precursors is known, or may be performed in analogy to known methods respectively, using suitable precursors, which are hydrolyzed and condensed. The application of a sol-gel or sol-gel precursors is known per se and may be performed in analogy to known methods, for example by spin-coating, dip coating, spraying or flow coating. The precursors used in these methods already contain the described functional groups of the formula (I). The manufacturing according to i) is preferred.

### Polymer Layers:

Provided the matrix is a polymer layer, the manufacturing method of the inventive coatings comprises either i) providing a polymer which is optionally dispersed in a liquid, and applying said polymer on the uncoated substrate or ii) applying of monomers which are optionally dispersed in a liquid on the uncoated substrate, with subsequent polymerization or iii) providing a substrate having an outer non-functionalized but functionalizable polymer layer and reacting said polymer layer with compounds containing functional groups of the formula (I). The manufacturing of a polymer, containing functional groups of formula (I), from the corresponding monomers is known, or may be performed in analogy to known methods using suitable monomers, which are subjected to a polymer-forming reaction (polymerization, polycondensation, polyaddition). Such polymer-forming reactions may be initiated catalytically, radically, photochemically (e.g. by UV) or be thermally. Further, either monomers containing these functional groups of the formula (I) may be polymerized (variants i and ii) or monomers containing no functional groups of the formula (I) are polymerized and the thus formed non-functionalized polymers are converted in one or more further reactions to functionalized polymers (variant iii). Further, it may be necessary or advantageous to provide the functional groups of the formula (I) in the course of the manufacturing process with protective groups. The polymer or the corresponding monomer may be provided in the form of the substance or in diluted form, i.e. in a liquid containing said polymer/monomer (suspension, emulsion, solution). The application of polymers, or of monomers respectively, is known per se and may be performed in analogy to known methods, for example by spin-coating, dip coating, spraying or flow coating.

### Active Polymers:

The manufacturing of active polymers, provided they contain one structural unit (homopolymers), is known and has been described. Active polymers containing two or more structural units of formula (I) (i.e. (Ia) and/or (Ib) and/or (Ic)) optionally of formula (II) and optionally of formula (III), may be manufactured in analogy to known methods. Thus, the manufacturing may take place, for example, by radical polymerization of the corresponding monomers using a suitable radical initiator at temperatures from 50 to 150° C. The molecular weight of the polymers thus prepared may be in the range of 1,000 to 10⁶ g/mol, while molecular weights from 1000 to 400,000 g/mol are preferred. Such polymerizations may take place in the presence of a diluent/solvent. Suitable solvents include alcohols, such as water-soluble mono- or di-alcohols, for example propanols, butanols, ethylene glycol as well as oxethylated mono-alcohols such as butyl glycol, butyl diglycol and Isobutyl glycol. In general, clear solutions are obtained after polymerization.

### Additional Process Steps:

Additional steps, known per se, such as cleaning steps, work-up steps, activating steps, may precede or follow the manufacturing methods described herein. Such additional steps depend upon, inter alia, on the choice of components and are known to the person skilled in the art. These additional steps may be of mechanical nature (e.g. polishing) or of chemical nature (e.g. etching, passivation, activation, bating, plasma treatment).

The invention relates, in a fourth aspect, a method for manufacturing the above-described devices, characterized in that either—processes a)—a device containing an uncoated substrate is provided and this device is coated with a coating as described herein or—process b)—a substrate containing a coating as described herein is provided and this coated substrate is applied to the device.

These methods are known per se, but were not yet applied to the specific coatings. The methods a) and b) differ in the application of the coating onto the device.

According to method a), the desired device is first produced, optionally primed (for example cleaning or activating), and then coated. For doing so, all current coating process may be considered; in particular processes, as used in the field of painting, printing or laminating. According to this process, semi finished goods or finished products may be manufactured.

According to method b), an intermediate product (the coated substrate) is produced first which is connected to a preliminary product such that the above device results. For this, all common material-fitting, friction-fitting, form-fitting joining methods may be considered. Typically, the inventive coating is applied to a flexible film which is glued to a corresponding substrate so as to obtain a coated device. Alternatively, a shaped article may be coated and be fastened by gluing, welding, riveting or the like on an uncoated substrate, so as to obtain a coated device.

### Methods to Accomplish the Invention:

The invention is further illustrated by the following, non-limiting examples.

### 1. Synthesis

TABLE 1
Chemicals

| | Molecular mass | purity | bp |
|---|---|---|---|
| Name | [g/mol] | [%] | [° C.] |
| 30% hydrogen peroxide | — | 30.0 | — |
| ethanol p.a. | 46.07 | >99.8 | 79 |
| NaOH (pellets) | 40.00 | 99.5 | 82 |
| polyvinylpyrrolidone K90 | 360000 | — | — |
| (Fluka) | | | |
| hydrochloric acid | 36.46 | 37.0 | 105 |
| (Fluka) | | | |
| Tetraethyl orthosilicate | 203.32 | — | 168 |
| (Aldrich) | | | |
| thf, anhydrous | 72.11 | 99.0 | 67 |
| (Fluka) | | | |
| copolymer* | Mₙ = 5200 | — | — |
| | M_{w} = 18000 | | |
| 6-azidosulfonyl hexyl- | 353.51 | | |
| triethoxysilane (ABCR) | | | |
| 3-(isocyanatopropyl | 247.36 | 95.0 | 283 |
| tiethoxy) silane (Aldrich) | | | |

*The copolymer used consists of monomers of the formula Ia (wherein R is methyl, A is 1,2-propyl-diene, B is 1,2-ethyl-diene, x is 1 to 5 and y is 3 to 40) and from monomers of the formula Ib (wherein R² and R³ with the nitrogen atom and the carbonyl group form a caprolactam)

### Variant A:

In a 50 ml beaker, x g polyvinylpyrrolidone (M=360000, Table 2) are dissolved in 40 ml of ethanol p.a. By the use of a pipette, y g tetraethyl orthosilicate (table 2) are added to the dissolved polymer. To start the sol-gel process, 0.5 ml of hydrochloric acid (1 mol/L) is added to the reaction solution. The reaction mixture is stirred for 1 hour at room temperature.

### Variant B^{1/2}:

In a 50 ml beaker, x g polyvinyl pyrrolidone (M=360000; see table) is dissolved in 40 mL of ethanol p.a. In a 25 ml beaker, y g tetraethyl orthosilicate (see table), dissolved in 10 ml of ethanol p.a., is treated with 0.5 ml hydrochloric acid (1 mol/L) to start hydrolysis. After a reaction time of 1 hour, the pre-hydrolyzed tetraethyl orthosilicate is added to the dissolved polyvinyl pyrrolidone. The reaction mixture is stirred for an additional hour at room temperature.

B¹ substrates are cured for 1 hour at 100° C.

B² substrates are cured overnight at 100° C.

TABLE 2
gels according to variant A and B

| | PVP [x g] | TEOS [y g] | ratio [M %] |
|---|---|---|---|
| gel 1 | — | 3.00 | 0:100 |
| gel 2 | 0.15 | 2.85 | 5:95 |
| gel 3 | 0.75 | 2.25 | 25:75 |
| gel 4 | 1.5 | 1.50 | 50:50 |
| gel 5 | 2.25 | 0.75 | 75:25 |
| gel 6 | 2.85 | 0.15 | 95:5 |
| gel 7 | 0.90 | 2.10 | 30:70 |
| gel 8 | 1.20 | 1.80 | 40:60 |
| gel 9 | 1.35 | 1.65 | 45:55 |
| gel 10 | 2.90 | 0.10 | 97:3 |
| gel 11 | 2.95 | 0.05 | 98:2 |

### Variant C:

In a 50 ml beaker, 7.50 g of copolymer is dissolved in 40 ml of ethanol p.a. By the use of a pipette, 1.25 g of tetraethyl orthosilicate is added to the dissolved polymer. To start the sol-gel process, 0.5 ml hydrochloric acid (1 mol/L) is added to the reaction solution; and subsequently stirred for 1 h at room temperature.

### Variant D:

In a 50 ml beaker, 30 g of copolymer is dissolved in 40 mL of anhydrous thf and reacted with 3 g (3-isocyanatopropyl) triethoxysilane overnight. Afterwards, 20 g of the reacted copolymer was added to 7 g of tetraethyl orthosilicate in 20 ml of ethanol. To start the sol-gel process, 0.5 ml hydrochloric acid (1 mol/L) were added to the reaction solution. The reaction mixture is stirred for 1 h at room temperature.

In this variant, the active polymer is covalently bound to the matrix of the sol-gel type and forms a very stable coating, see no. 4.

### Variant E:

2.8 g tetraethyl orthosilicate (TEOS) and 0.2 g of 6-Azidosulfonylhexyl triethoxysilane are dissolved in 10 ml of absolute ethanol. 0.7 ml of 1 molar hydrochloric acid is added and the solution is stirred for 2 h at room temperature. Subsequently, a solution of 2 g polyvinyl pyrrolidone (PVP) in 20 ml of absolute ethanol are added and stirred for about 22 h at room temperature. With this solution, glass slides are dip-coated. After air drying for 0.5 hours, the coated slides are cured for 5 hours at 160° C.

### 2. Analysis

### 2.1 Anti-Icing Test

To test the anti-icing effect, the coated substrate is stored 120 minutes at −20° C. In defined time intervals, moist warm air is supplied to the coated substrate. In the present case, the coated substrates were stored in a refrigeration compartment; moist warm air was supplied by opening the door. Subsequently, the coating of the substrate was tested for anti-icing effectiveness. In addition, the tests are conducted with an uncoated substrate. It is possible to use its icing as a negative reference.

TABLE 3
Coated substrates according to variants A-C

| manufacturing | | etching | | | | |
|---|---|---|---|---|---|---|
| according to | | system H₂O₂/ | pre-treatment | | | |
| variant | substrate* | NaOH | in O2-plasma | Dipcoating | painting | result |
| A | glass | x | | x | | xx |
| reference | glass | | | | | - |
| B | glass | x | | x | | xx |
| reference | glass | | | | | - |
| C | glass | x | | x | | xx |
| reference | glass | | | | | - |
| D | glass | x | | x | | xx |
| reference | glass | | | | | - |
| E | glass | | | x | | xx |
| reference | glass | | | | | - |
| A | Stahl | | | x | | xx |
| reference | Stahl | | | | | - |
| A | PVC | | x | x | | xx |
| reference | PVC | | | | | - |
| A | POM | | x | x | | xx |
| reference | POM | | | | | -- |
| A | PE | | x | x | | xx |
| reference | PE | | | | | - |
| A | PA | | x | x | | xx |
| reference | PA | | | | | - |
| A | PP | | x | x | | xx |
| reference | PP | | | | | - |
| A | ABS | | x | x | | xx |
| reference | ABS | | | | | - |
| A | PS | | x | | x | xx |
| reference | PS | | | | | - |
| A | pc | | | | x | xx |
| reference | pc | | | | | - |

*pc = printed cardboard

After running the above-mentioned tests, all samples marked with “xx” show a pronounced anti-icing effect, when compared to the uncoated reference labelled “−” (table 3). Even after 3 days of storage at −20°, the coated samples are ice-free, in contrast to the blanks.

### 2.2 Layer Thickness

After each layer application the preceding layer is dried for 2 min. The layer thickness is measured by a micrometer screw (0-0.25 mm). The manufacturer's specified measurement accuracy is 0.001 mm. In each case, three measurements of the uncoated part and three of the coated part were done; subsequently, the mean value was determined. The measuring points are located side-by-side, to consider an uneven thickness of the slide. The layer thickness may be taken from the table below.

TABLE 4
layer thickness of gel 5

| number of | | coating + slide | layer thickness |
|---|---|---|---|
| layers | slide [μm] | [μm] | [μm] |
| 1 | 970 | 973 | 3 |
| 3 | 970 | 999 | 29 |
| 5 | 971 | 1012 | 41 |

Variant E coatings show a layer thickness of 6.4 +/− 1.3 μm.

### 2.3 Effectiveness

The samples are stored at −20° C. According to the time intervals indicated, the effectiveness of the coatings is monitored. The effectiveness may be taken from the following table, wherein “o” denotes ice-free and “K” denotes spare ice crystals. The layers are effective when showing a thickness as low as 3 μm.

TABLE 5
icing of gel 5

| | time of storage at −20° C. | | |
|---|---|---|---|
| number of layers | 5 min | 20 min | 120 min |
| 1 | ∘ | ∘ | K |
| 3 | ∘ | ∘ | ∘ |
| 5 | ∘ | ∘ | ∘ |

### 2.4 IR-Studies

By means of IR spectroscopy, it is possible to determine the ratio of linked Si—O—Si units to free Si-O units. The assignment of IR bands indicated below is made with gels according to variant A:

| 2.4.1 | silica sceleton: |
|---|---|
| 798 | ring structure of SiO₄ tetraeders |
| 950 | Si—O— |
| 1094 | Si—O—Si stretching vibration |
| 1635 | H—O—H H₂O deformation vibration |
| 3430 | Si—OH stretching vibration of surface silanol hydrogen |
| | and vibration structures of Si—O—Si |
| 2.4.2 | polyvinyl pyrrolidon: |
| 1270 | C—N valence vibration |
| 1420 | C—H deformation vibration vicinal to C═O |
| 1650 | C═O |
| 2900 | saturated C—H |
| 3400 | O—H water |

Based on the relative ratio of the IR bands, a relative degree of cross-linking is estimated; see table 6.

TABLE 6

| | | cross-linking [%] |
|---|---|---|
| variant A | | |
| 0:100 | gel 1 | 100 |
| 05:95 | gel 2 | 92 |
| 25:75 | gel 3 | 79 |
| 50:50 | gel 4 | 78 |
| 75:25 | gel 5 | 77 |
| 95:05 | gel 6 | 65 |
| variant B¹ | | |
| 0:100 | gel 1 | 100 |
| 05:95 | gel 2 | 91 |
| 25:75 | gel 3 | 73 |
| 50:50 | gel 4 | 67 |
| 75:25 | gel 5 | 49 |
| 95:05 | gel 6 | 46 |
| variant B² | | |
| 0:100 | gel 1 | 100 |
| 05:95 | gel 2 | 85 |
| 25:75 | gel 3 | 83 |
| 50:50 | gel 4 | 51 |
| 75:25 | gel 5 | 28 |
| 95:05 | gel 6 | 16 |

The bands at 1094 cm-1 and at 950 cm-1 may be assigned to linked Si—O—Si units and free Si—O units respectively. Based on the ratio of these two bands to each other, a conclusion about the relative cross-linking of the silica skeleton can be made. To the pure silica gel, a ratio of Si—O—Si to Si—O and a Si-density of 100 is assigned. For the other gels, having an increasing PVP content, a decreased cross-linking can be determined in comparison to pure TEOS.

### 2.5 Anti-Icing Effect

An anti-icing effect is observed at a relative cross-linking of 15-80% of baseline. A cross-linking below 15% can not be determined experimentally at the conditions given. Effective cross-linking may be present at lower levels, but this may not be resolved by the present measuring method. At higher levels of cross-linking, no effect is observed. Detailed information may be taken from table 7.

TABLE 7
Anti-icing effect

| | | Anti-icing effect | properties |
|---|---|---|---|
| varinat A | | | |
| 0:100 | gel 1 | − | opaque |
| 05:95 | gel 2 | − | opaque |
| 25:75 | gel 3 | − | transparent |
| 30:70 | gel 7 | + | transparent |
| 50:50 | gel 4 | + | transparent |
| 75:25 | gel 5 | + | transparent |
| 95:05 | gel 6 | + | transparent |
| varinat B^{1, 2} | | | |
| 0:100 | gel 1 | − | opaque |
| 05:95 | gel 2 | − | opaque |
| 25:75 | gel 3 | − | transparent |
| 50:50 | gel 4 | + | transparent |
| 75:25 | gel 5 | + | transparent |
| 95:05 | gel 6 | + | transparent |

### 3. Variation Monomers in the Active Polymer

Copolymers were used, in which the amount of caprolactam has been increased. The copolymer is covalently bound to the sol-gel matrix via the free OH groups. In doing so, the (3-isocyanatopropyl) triethoxysilane is reacted therewith and subsequently linked with TEOS.

TABLE 8
Dependence of water uptake by the
proportion of Caprolactam in [mol]

| co-polymer** | water uptake [mg] |
|---|---|
| MA 350/NVC: 1/2 molar | 0.3 |
| MA 350/NVC: 1/2.5 molar | 1.3 |
| MA 350/NVC: 1/3 molar | 1.9 |
| MA 350/NVC: 1/4 molar | 2.1 |

**The copolymer used consists of of MA350 (monomers of the formula Ia (where R¹ represents methyl, A represents 1,2-Propyldien, B represents 1,2-Ethyldien, x represents 1 to 5 and y represents 3 to 40) and NVC (monomers of the formula Ib (where R² and R³ including the nitrogen atom and the carbonyl group form a caprolactam).

It is found that the water uptake increases with the proportion of caprolactam-units and thus an improved anti-icing effect is achieved.

### Isocyanate—Residual

The isocyanate group is combined with dibutylamine, which is dissolved in xylene. Aliphatic secondary amines rapidly and quantitatively react with isocyanates to trisubstituted ureas. Subsequently, the excess amine is titrated with hydrochloric acid. The titration's equivalence point is characterized by an inflection point of the titration curve.

Calculation of the results:

$${w}_{( NCO )} = \frac{( a - b ) \cdot t \cdot c \cdot M}{EW \cdot 10}$$

W_{(NCO)}=content of NCO in %
   a=consumption of HCl standard solution at the effective value in ml
   b=consumtion of HCl standard solution of the probe in ml
   t=Titer of the HCl-standard solution
   c=molar concentration of the standard solution, in the present case c=0.5 mol/l
   M=molar mass NCO=42 g/mol
   EW=sample weight in g

The residual isocyanate content of the samples is between 0-1.8% of the starting amount; a full conversion may thus be assumed. The copolymer was linked to (3-isocyanatopropyl) triethoxysilane and then covalently bound via the terminal group to the sol-gel matrix.

### 4. Water Resistance Test

Plates, coated according to variant A-D, are placed for 10-15 min under running tap water and then placed for 2 d in a bath of tap water. The test is deemed to be passed if an anti-icing effect may be observed afterwards.

TABLE 2
Water resistance of the coatings

| sample name | Test passed | Test not passed |
|---|---|---|
| variant A | | x |
| variant B | | x |
| variant C | | x |
| variant D | x | |

The coatings according to variant D, where the active polymer is covalently bonded, pass the water resistance test. The coatings according to variants A-C, where the active polymer is incorporated, dissolved during said test. This shows that coatings of variants A-C also show an anti-icing effect, but not such strong water resistance as those of variant D.

The coatings on variant E are not soluble, neither under running water nor in a beaker filled with water.

### 5. Variation in Layer Thickness

The effect of the layer thickness of the inventive coatings on the anti-icing property was investigated. Different thicknesses were achieved by multiple coating. The water uptake tests were performed in a climate chamber, at 10° C. and a humidity of 80%, for 3 days. The amount of water was determined from the weight increase after 3 days. In doing so, the ability of water uptake of the coating is determined.

TABLE 10
Dependence of water uptake of layer thickness for variant A

| layer thickness [μm] | water uptake [mg] |
|---|---|
| 10 | 0.2 |
| 15 | 1.6 |
| 35 | 2.2 |

TABLE 11
Dependence of water uptake of layer thickness for variant D

| layer thickness [μm] | water uptake [mg] |
|---|---|
| 8 | 0.5 |
| 12 | 4.4 |
| 18 | 5.6 |

The amount of water absorbed is highly dependent on the layer thickness of the coating see tables 10 and 11). The water uptake may not be increased indefinitely by increasing the film thickness. The amount of water absorbed reaches a limit. Accordingly, when considering the coating material, a maximum anti-icing effect can be achieved by choosing a suitable layer thickness. Compared to known coatings, the inventive coatings described herein show significant anti-icing at very low film thicknesses.

1. A Coating comprising a matrix and incorporated therein an active polymer, wherein
a. the active polymer is covalently bound to the matrix; and
b. the active polymer
i. consists of structural units of the formula (Ia); or
ii. comprises structural units of the formula (Ia) and (Ib); or
iii. comprises structural units of the formula (Ia) and (Ic); or
iv. comprises structural units of the formula (Ia) and (Ib) and (Ic) 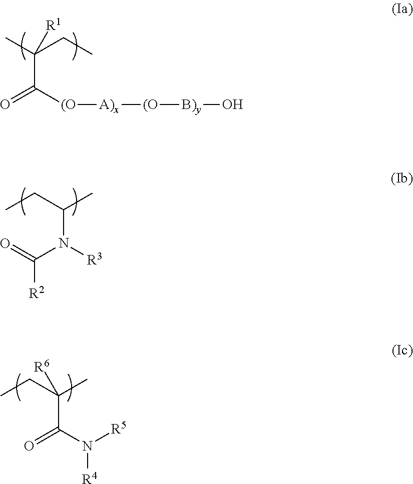
wherein
R¹ is hydrogen or C₁-C₆-alkyl,
A is a C₂-C₄-alkylene group,
B is a C₂-C₄-alkylene group, with the proviso that A is different from B,
x, y independently are an integer from 1-100,
R² and R³ independently are hydrogen or C₁-C₆-alkyl, or
R² and R³—together with the nitrogen atom and the carbonyl group—form a ring of 5, 6 or 7 ring atoms,
R⁴ and R⁵ independently are hydrogen or C₁-C₆-alkyl or C₁-C₆-cycloalkyl or
R⁴ and R⁵— together with the nitrogen atom-form a ring of 5, 6 or 7 ring atoms,
R⁶ is hydrogen or C₁-C₆-alkyl; and
c. at least one crosslinker and/or coupling reagent are optionally present.

2. The coating according to claim 1, whereby
a. the matrix is selected from the group consisting of sol-gels and polymer layers;
b. the active polymer comprises 1-100 Gew. % structural units of the formula (Ia), (Ib) and/or (Ic) and
i. consists of structural units of the formula (Ia); or
ii. comprises structural units of the formula (Ia) and (Ib); or
iii. comprises structural units of the formula (Ia) and (Ic); or
iv. comprises structural units of the formula (Ia) and (Ib) and (Ic)
c. the active polymer is covalently embedded in the matrix by reaction with a coupling agent of formula (IIIa) or (IIIb) 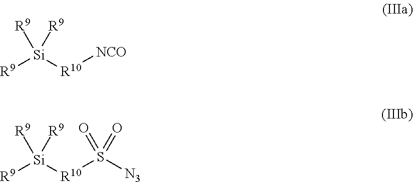
wherein
R¹⁰ is a bi-functional hydrocarbon residue having 1-20 carbon atoms,
R⁹ independently is a hydrolizable group.

3. The coating of claim 2, whereby the ratio of active polymer to matrix is in the range from 30:70 to 98:2 (w/w).

4. The coating of claim 2, whereby the active polymer contains 40-60 wt.-% structural units of formula (I).

5. The coating of claim 2, whereby the active polymer contains 40-60 wt-% structural units of formula (I), and whereby said structural units form a lactam.

6. The coating of claim 2, whereby the active polymer contains 10-50 wt.-% coupling agent of formula (IIIa) or (IIIb).

7. The coating of claim 2, whereby the active polymer contains 10-50 wt.-% coupling agent of formula (IIIa) or (IIIb), and whereby R⁹ is C₁₋₈ alkoxy and R¹⁹ is C₁₋₁₀ alkandiyl.

8. The coating of claim 2, whereby the matrix is selected from the group consisting of sol-gels.

9. The coating of claim 1, whereby the active polymer consists of structural units of formula (Ia) and (Ib) in a molar ratio of 1:2 to 1:6.

10. A shaped article comprising a substrate and a coating according to claim 1 as an outer layer.

11. The shaped article according to claim 10, whereby the substrate surface consists of material selected from the group consisting of
a. metallic materials,
b. ceramics,
c. glass-like materials,
d. polymeric materials, and
e. cellulosic materials.

12. A device comprising a shaped article according to claim 11, selected from the group consisting of
f. rotor blades for wind turbines, high voltage power lines;
g. wings, blades, fuselage, antennas, windows of aircrafts; Viewing windows of motor vehicles; hull, mast, fin rudder, takelage of ships; external surfaces of railway wagons; surfaces of traffic signs;
h. lining of refrigerators;
i. Packaging of foodstuffs;
j. sensors;
k. devices for the transport of ice slurry; surfaces of solar systems; surfaces of heat exchangers; and
l. surfaces coming into contact with gases upon transportation of crude oil or natural gas.

13. A process for manufacturing a coating having anti-icing properties, wherein the coating comprises an active polymer according to claim 2.

14. A process for anti-icing a shaped article, comprising the step of coating the shaped articles with a coating as defined in claim 1.

15. A method for manufacturing a coating comprising the steps of
a. providing a substrate which is optionally activated;
b. providing a composition comprising a matrix and an active polymer according to claim 1; and
c. coating the substrate with the composition.

16. The coating of claim 2, whereby the active polymer contains 40-60 wt.-% structural units of formula (I), and whereby said structural units form a caprolactam.

17. A method for manufacturing a coating comprising the steps of
a. providing a substrate which is optionally activated;
b. providing a composition comprising a matrix and an active polymer according to claim 1; and
c. coating the substrate with the composition by way of dip-coating or spray-coating.
